(19) United States
(12) Patent Application Publication
(10) Pub. No.: US 2010/0111146 A1
(43) Pub. Date: May 6, 2010

(54) COMMUNICATION DEVICE AND COMMUNICATION SYSTEM

(75) Inventors: Tatsuo NAKAGAWA, Kokubunji (JP); Masayuki MIYAZAKI, Tokyo (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/611,137

(22) Filed: Nov. 3, 2009

(30) Foreign Application Priority Data
Nov. 4, 2008 (JP) 2008-282807

(51) Int. Cl. H04B 1/38; H04L 25/49; H04L 27/00; H04L 7/00

(52) U.S. Cl. 375/220; 375/296; 375/259; 375/356

(57) ABSTRACT

A communication device with digital and analog circuits mixedly mounted thereon, for which the influence of noise generated in its interface part on the analog circuit part can be reduced, which does not interfere with the downsizing of the communication device. The communication device has a communication part, such as semiconductor communication device, and a control part, such as a semiconductor control device operable to control the communication part. The communication part and control part are operated in asynchronization with each other. The communication part includes an analog circuit. The interface circuit of the communication part, which is interfaced with the control part, receives a clock signal supplied from the communication part and conducts a synchronous interface. The control part stops supplying the clock signal during the time when the communication part operates the analog circuit.

### CLAIM OF PRIORITY

The Present application claims priority from Japanese application JP 2008-282807 filed on Nov. 4, 2008, the content of which is hereby incorporated by reference into this application.

### FIELD OF THE INVENTION

The present invention relates to a communication device and a communication system using the same. Particularly, it relates to a technique useful in the application to a communication module, which has e.g. a semiconductor communication device with an analog circuit and another semiconductor device operable to control the communication device.

### BACKGROUND OF THE INVENTION

In recent years communication technology has made surprising progress, and a wide variety of communication services including the Internet and mobile phones have been offered. In addition, a ubiquitous society such that every device is connected to a network, works in cooperation autonomously and backs up human life is expected to become reality in no distant future. To such ubiquitous society, ultraminiature communication devices are de rigueur because they are embedded and used in various goods or articles.

In regard to communication systems, digital communication ones are becoming the mainstream instead of analog communication systems. The reason for this is that digital communications have the advantages of being smaller in the effect of noise in the course of transmission in comparison to analog communications, the practicability of compression of information, and being easy to keep information. In digital communication, a transmitter converts a digital signal into an analog signal and then sends the signal, whereas a receiver converts a received analog signal into a digital signal. Therefore, a digital communication device is a device equipped with both digital and analog circuits inevitably.

In general, it is known for a device equipped with both analog and digital circuits, the noise from the digital circuit, which would travel into the analog circuit, must be reduced. A non-patent document presented by Eastman, N. L., “Considerations for mixed analog/digital PCB design,” WESCON/96, pp. 297-301, 22-24 Oct. 1996, discloses a technique for designing a printed circuit board equipped with both analog and digital circuits. In the non-patent document, it is described that the layout of parts or components, impedance control, and separation of the power sources and grounds are effective in reducing the noise.

Further, a patent document, Japanese Unexamined Patent Application Publication No. JP-A-2003-37172 discloses a method for eliminating the disadvantage that an analog circuit receives digital noises attributed to clock signals, and thus analog signals are degraded in quality. Specifically, the inside of the IC chip is divided into analog and digital circuit regions in terms of the layout, and a clock generator operable to generate a clock signal is arranged in the digital circuit region, and a switching circuit operable to conduct a switching operation according to the clock signal is arranged in the digital circuit region, whereby the wiring length of the clock line extending from the clock generator to the switching circuit is shortened, and the distance from the clock line to the analog circuit in the analog circuit region can be maximized. In this way, the disadvantage that digital noises caused by clock signals traveling on a clock line enter the analog circuit is eliminated.

### SUMMARY OF THE INVENTION

It has been known that making longer the physical distance between the analog and digital circuits as described by the non-patent document presented by Eastman, N. L. and the patent document JP-A-2003-37172 is effective as means for reducing the digital noise which would go into the analog circuit. Further, another means by which power sources for the analog and digital circuits and the grounds thereof are separated, and the grounds are connected to one point has been known. However, such techniques cannot offer an effective measure against the occurrence of spurious noise in an interface part between a semiconductor communication device with an analog circuit and a semiconductor control device serving to control the communication device, which has been found by the inventor. Specifically, for example, data and command exchanges are synchronously performed between a semiconductor communication device working in synchronization with a clock and a semiconductor control device working in synchronization with another clock through an interface part located between the devices, in which the semiconductor communication device uses a synchronizing clock signal of the semiconductor control device. However, during such action, it is required to perform input and output actions in synchronization with the semiconductor control device, and therefore, both a circuit part working in synchronization with the synchronizing clock signal of the semiconductor control device and a circuit part working in synchronization with the synchronizing clock signal of the semiconductor communication device are provided in the interface part of the semiconductor communication device. On this account, the occurrence of spurious noise cannot be prevented. Besides, a circuit with a large driving power works in the interface circuit part, and such circuit causes a large noise. Under such situation, the techniques described in the documents cited above cannot offer any measures. No matter how far the communication and control devices are spaced apart from each other, the occurrence of spurious noise cannot be avoided. In addition, there are limits to the extent to which the distance between the interface circuit and communication circuit can be enlarged inside the semiconductor communication device, and to the electromagnetic separation thereof. Even if increasing the distance between the interface and communication circuits and electromagnetically separating them, the chip per se would be made larger, and the cost would be raised. The upsizing of the chip, and the increase in area are undesirable for a communication device, such that downsizing thereof is a must, e.g. a device intended for a ubiquitous network.

Therefore, it is an object of the invention to provide a communication device equipped with both digital and analog circuits, which can achieve both the reduction in the influence of noise produced in an interface part thereof on the analog circuit and downsizing.

Further, it is another object of the invention to provide a communication system which can suppress a communication malfunction attributed to spurious noise caused by synchronization in the interface part between circuits made to work out of synchronization, and which can still keep a downsized system form even after implementation of the measure against such spurious noise.

The above and other objects of the invention and novel features thereof will be apparent from the description hereof and the accompanying drawings.

Of preferred embodiments of the invention herein disclosed, a preferred one will be briefly outlined below.

That is, the communication device has a communication part, such as a semiconductor communication device, and a control part, such as a semiconductor control device for controlling the communication part. The communication part and control part are operated in asynchronization with each other. The communication part includes an analog circuit. The interface circuit of the communication part interfaced with the control part receives a clock signal supplied by the communication part, and performs a synchronous interface. The control part stops supplying the clock signal during the time when the communication part is operating the analog circuit.

Now, the effects achieved by the preferred embodiments of the invention herein disclosed will be described below briefly.

That is, in regard to a communication device with digital and analog circuits mixedly mounted therein, the influence of noise generated in the interface part on an analog circuit part can be reduced. Widening the physical distance between analog and digital circuits does not make a requirement for such communication device, and therefore nothing interferes with the downsizing of the device. Adopting such communication device for a communication system, a communication malfunction attributed to spurious noise caused owing to synchronization in an interface part located between circuits operated in asynchronization with each other can be suppressed, and the system can be kept in a downsized form even after a measure against spurious noise has been taken.

### BRIEF DESCRIPTION OF THE DRAWINGS

FIG. 1 is a diagram showing a configuration of a transmit terminal according to the first embodiment of the invention;

FIG. 2 is an action flowchart of the transmit terminal according to the first embodiment of the invention;

FIG. 3 is a control sequence diagram of the transmit terminal according to the first embodiment of the invention;

FIG. 4 is a timing chart of the transmit terminal according to the first embodiment of the invention;

FIG. 5 is a diagram showing a configuration of a receive terminal according to the second embodiment of the invention;

FIG. 6 is an action flowchart of the receive terminal according to the second embodiment of the invention;

FIG. 7 is a control sequence diagram of the receive terminal according to the second embodiment of the invention;

FIG. 8 is a timing chart of the receive terminal according to the second embodiment of the invention;

FIG. 9 is a diagram showing a configuration of a communication terminal according to the third embodiment of the invention;

FIG. 10 is an action flowchart of the communication terminal according to the third embodiment of the invention;

FIG. 11 is a control sequence diagram of the communication terminal according to the third embodiment of the invention;

FIG. 12 is a timing chart of the communication terminal according to the third embodiment of the invention;

FIG. 13 is a diagram showing examples of characteristic curves of BER to signal-to-noise ratios;

FIG. 14 is diagram showing Sensor Net and sensor nodes in connection with the fourth embodiment of the invention; and

FIG. 15 is a diagram showing an example of the interface circuit of a semiconductor communication device on the controlled side.

### DETAILED DESCRIPTION OF THE PREFERRED EMBODIMENTS

### 1. Summary of the Preferred Embodiments

The preferred embodiments of the invention herein disclosed will be outlined first. Here, the reference numerals, characters and signs for reference to the drawings, which are accompanied with paired round brackets, only exemplify what the concepts of components and elements referred to by the numerals, characters and signs contain.

[1] A communication device (100, 500, 900) according to the invention has a communication part (102, 502, 902) and a control part (101), which are operated in asynchronization with each other. The communication part has an analog circuit for communication (109, 112), and an interface circuit (114) connected with the control part. The interface circuit serves to synchronously interface between the communication part and the control part in synchronization with a first clock signal (SCLK) output from the control part. After having issued the communication part with a direction of a communication action, the control part stops supply of the first clock signal to the communication part until it receives a notice of the end of a communication action relevant to a direction thereof from the communication part. Thus, the influence of noise caused in the interface circuit on the analog circuit can be reduced. This means does not impose the requirement of enlarging the physical distance between the analog and digital circuit, so it never interferes with the downsizing of communication devices. Adopting such communication device for a communication system, a communication malfunction attributed to spurious noise caused owing to synchronization in an interface part located between circuits operated in asynchronization with each other can be suppressed, and the system can be kept in a downsized form.

[2] In the communication device as stated in [1], the communication part is a transmit part (102).

[3] In the communication device as stated in [2], the control part provides transmit data to the transmit part separately from a direction for a transmit action.

[4] In the communication device as stated in [2], the transmit part outputs a notice signal (S_TXMNT) for notifying the control part of a transmit operation state, and the control part accepts end of the transmit action with aid of the notice signal.

[5] In the communication device as stated in [1], the communication part is a receive part (502).

[6] In the communication device as stated in [5], the receive part stores the receive data in a data buffer (110), and then sends a notice of end of a receive action to the control part.

[7] In the communication device as stated in [5], the receive part outputs a notice signal (S_RXMNT) to notify the control part of a receive operation state, and the control part accepts end of the receive action with aid of the notice signal.

[8] In the communication device as stated in [1], the communication part is transceiver part (902).

[9] In the communication device as stated in [8], the transceiver part outputs a notice signal (S_MNT) to notify the control part of a communication operation state, and the control part accepts the end of the communication operation with the aid of the notice signal. A first level of the notice signal shows that the transceiver part is in course of transmission or reception, whereas a second level thereof shows that the transceiver part is in course of neither transmission nor reception.

[10] In the communication device as stated in [1], the interface circuit has: a first latch circuit (202A) operable to latch a signal supplied to an input buffer (200) from the control part in synchronization with the first clock signal; a second latch circuit (203A) operable to latch the latched signal of the first latch circuit in synchronization with a second clock signal (T_CLK) generated in the communication part; a third latch circuit (203B) operable to latch a signal to be output to the control part in synchronization with the second clock signal; and a fourth latch circuit (202B) operable to latch the latched signal of the third latch circuit in synchronization with the first clock signal, and to provide the latched signal to an output buffer (201).

[11] In the communication device as stated in [10], the first clock signal differs from the second clock signal in frequency.

[12] The communication device as stated in [1] is modularized by including a semiconductor integrated circuit chip constituting the control part; and a semiconductor integrated circuit chip constituting the communication part.

[13] A communication system according to the invention includes a plurality of communication devices (1400, 1401), and at least one communication device has a communication part and a control part, which are operated in asynchronization with each other. The communication part has an analog circuit for communication, and an interface circuit connected with the control part. The interface circuit synchronously interfaces between the communication part and control part in synchronization with a first clock signal output from the control part. The control part issues the communication part with a direction of a communication action, and then stops supplying the first clock signal to the communication part during time when the analog circuit is in action. When adopting the communication device for a communication system, a communication malfunction attributed to spurious noise caused owing to synchronization in an interface part located between circuits operated in asynchronization with each other can be suppressed, and the system can be kept in a downsized form.

[14] In the communication system as stated in [13], after having issued the communication part with a direction of a communication action, the control part stops supplying the first clock signal to the communication part until receiving a notice signal of end of a communication action associated with the direction from the communication part.

[15] In the communication system as stated in [13], at least one of the communication devices is abase station (1401), the remaining communication devices are terminals (1400), and the terminal has a sensor (1408), and sends data captured by the sensor to the base station.

[16] The communication system as stated in [15] further includes a server (1403) with which the base station is connected through a network (1402).

### 2. Further Detailed Description of the Preferred Embodiments

Now, the embodiments will be described further in detail.

### First Embodiment

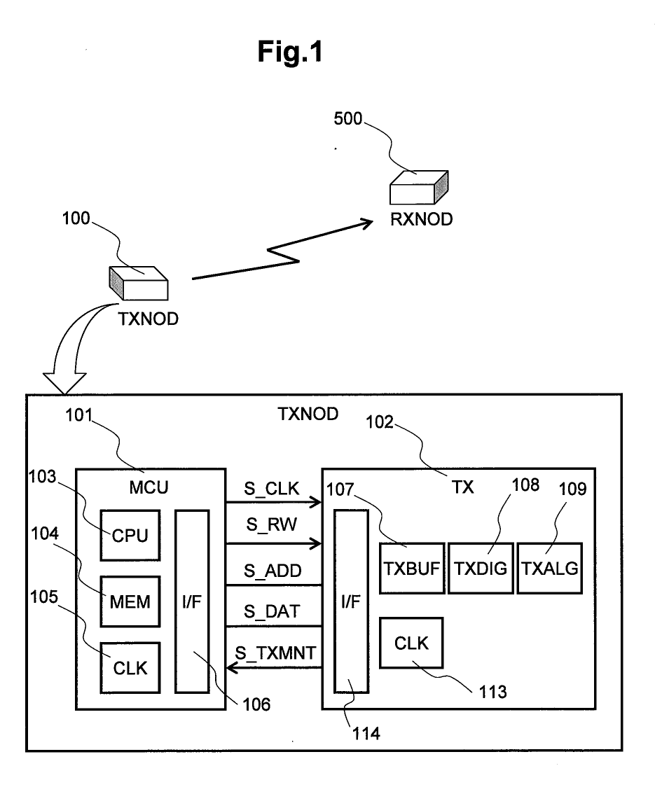

The first embodiment of the invention will be described with reference to FIGS. 1 to 4. FIG. 1 shows a communication system according to the first embodiment of the invention, and it also shows a configuration of a transmit terminal thereof. The communication system in connection with the first embodiment includes a transmit terminal (TXNOD) 100 and a receive terminal (RXNOD) 500. The transmit terminal 100 sends data to the receive terminal 500.

The transmit terminal 100 includes a micro controller unit (MCU) 101 and a transmitter (TX) 102. The micro controller unit 101 is formed, as a semiconductor device, in one semiconductor chip, which has a central processing unit (CPU) 103, a memory (MEM) 104, a clock generator (CLK) 105, and an interface (I/F) 106. The transmitter 102 is formed, as a semiconductor device for communication, in one semiconductor chip, which has a transmit buffer (TXBUF) 107, a transmit digital circuit (TXDIG) 108, a transmit analog circuit (TXALG) 109, a clock generator (CLK) 113, and an interface circuit (I/F) 114.

The micro controller unit 101 and transmitter 102 are connected with each other by a clock signal line (S_CLK), and a read/write signal line (S_RW) for selecting read or write, an address line (S_ADD), a data line (S_DAT), and a transmit monitor signal line (S_TXMNT). The signal and signal lines connect between the interface circuit 106 and interface circuit 114. The clock signal S_CLK is provided to the transmitter 102 from the micro controller unit 101, which is used as a clock in communication between the micro controller unit 101 transmitter 102. The address line S_ADD is used to indicate an address of a register or buffer to be accessed. To the data line S_DAT, data to be written to or read from an address indicated by the address line S_ADD is output. Whether data is read or written is specified by the read/write signal line (S_RW). The monitor line S_TXMNT is a signal line used to inform the micro controller unit 101 of the operation state of the transmitter 102.

The transmit terminal 100 according to the embodiment is a device such that both analog and digital circuits are mounted mixedly. The analog circuit refers to the transmit analog circuit 109 of the transmitter 102. The digital circuit refers to the micro controller unit 101, and the transmit buffer 107, transmit digital circuit 108, clock generator 113 and interface 114 of the transmitter 102.

In general, it has been known that an analog circuit is susceptible to noise coming from a digital circuit. Therefore, as to a device equipped with both analog and digital circuits, it is required to sufficiently reduce the influence of noise from the digital circuit on the analog circuit. As a technique for cutting a digital noise on an analog circuit, it is effective to widen the physical distance between digital and analog circuits. More specifically, a method which includes spacing the analog and digital regions, and separating their power sources and grounds, but connecting the grounds to one point has been known. By applying such typical technique to the communication device 102 which is an analog-digital mixed semiconductor IC, a measure against noise propagation from a digital circuit, such as the transmit digital circuit 108, to the transmit analog circuit 109 is taken. The inventor focused on the occurrence of spurious noise in an interface part of the communication device 102 as a semiconductor communication device with an analog circuit, and the micro controller unit 101 as a semiconductor control device for controlling the communication device. Particularly, in the case where the micro controller unit 101 has a clock frequency different from that of the communication device 102, a spurious having a component consisting of the product of multiplication of both the clocks is produced, which can deteriorate the communication performance largely. To cope with this, if the typical technique as described above is adopted, a large physical distance must be kept between the micro controller unit 101 and communication device 102. This goes against the requirement that devices must be downsized. For example, communication terminals for ubiquitous networks have a trade-off as follows. That is, communication terminals for ubiquitous networks are embedded in various locations and therefore, they need to be ultraminiaturized; however, such terminals cannot be so scaled down because of the need to reduce the noise. Hence, a noise reduction system is adopted for the transmit terminal 100, which differs from the typical conventional technique. This will be described below in detail.

The micro controller unit 101 controls the transmitter 102. An example of the control method therefor is the bus-connection system, which uses a clock signal line S_CLK, an address line S_ADD, a data line S_DAT, and a signal line S_RW for selecting read or write. In case that the micro controller unit 101 writes data into the transmitter 102, micro controller unit 101 supplies the transmitter 102 with a clock S_CLK, an address S_ADD, and the data S_DAT thereby to write the data to the indicated address in the transmitter 102. In case that the micro controller unit 101 reads out data from the transmitter 102, the micro controller unit 101 sends the transmitter 102 with the clock S_CLK and an address S_ADD, whereby the data corresponding to the indicated address in the transmitter 102 is read onto the data line S_DAT.

As the clock when the micro controller unit 101 reads/writes data from/into the transmitter 102, a clock signal generated by the clock generator 105 in the micro controller unit 101 is used. However, a clock generated by the clock generator 113 in the transmitter 102 is used for an action of the transmitter 102. Therefore, the interface circuit 114 of the communication device 102, which is a controlled circuit, is supplied with the clock signal S_CLK from the micro controller unit 101. In the case where the clock used by the micro controller unit 101 differs from the clock used by the transmitter 102 like this, a spurious noise having a frequency component consisting of the product of multiplication of both the clocks is produced. If the noise affects the transmit analog circuit 109 of the transmitter 102, the deterioration occurs in bit error rate or packet error rate, resulting in the degradation of communication performance.

Especially, in the case of high-speed communication, for speeding up communication between the micro controller unit 101 and transmitter 102, it is necessary to raise the frequency of the clock signal S_CLK, and in addition, the data line S_DAT will be increased in number. In this case, the circuit scale of the interface circuit 114 between the micro controller unit 101 and transmitter 102 is made larger, and the operating speed is increased, and therefore the noise coming from the interface circuit 114 becomes larger.

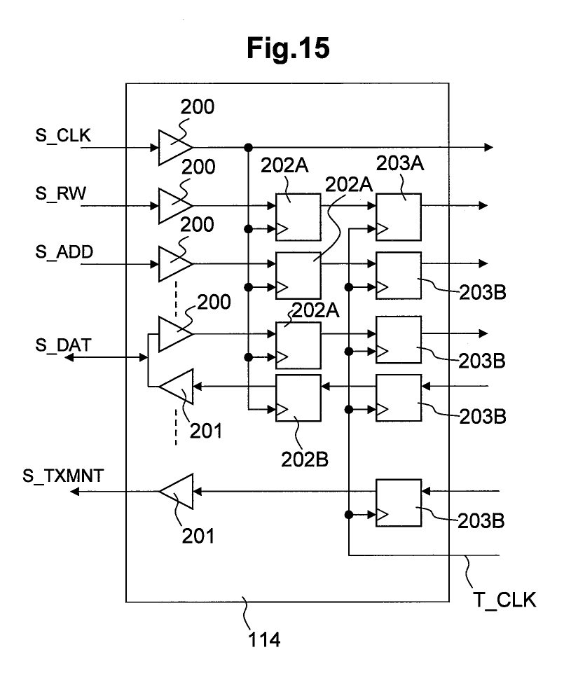

FIG. 15 shows an example of the interface circuit 114. The reference numeral 200 denotes an input buffer. The numeral 201 denotes an output buffer. The numerals 202A and 202B each denote a latch circuit working in synchronization with the clock signal S_CLK supplied from the micro controller unit 101. The numerals 203A and 203B each denote a latch circuit working in synchronization with the clock signal T_CLK generated by the clock generator 113 inside the transmitter 102. In this example, data and others are exchanged between the micro controller unit 101 and communication device 102, which are operated in asynchronization with each other, by being passed through a series of two stages of latch circuits 202A and 203A or latch circuits 202B and 203B. As is clear from the example of FIG. 15, in the interface circuit 114, circuits operated with the different clock signals S_CLK and T_CLK are provided in parallel, and buffers 200 and 201 requiring a large driving current are laid out near the circuits. As is apparent from this example, it is expected that a large spurious noise arises in the interface circuit 114 on the controlled side.

To reduce the influence of the spurious noise on the analog circuit, the micro controller unit 101 performs control so that outputting the clock signal S_CLK to the transmitter 102 is stopped until it receives a notice of the end of a transmit action from the transmitter 102 by use of the signal S_TXMNT after having issued the transmitter 102 with a direction for the transmit action and transmit data. This will be described below further in detail.

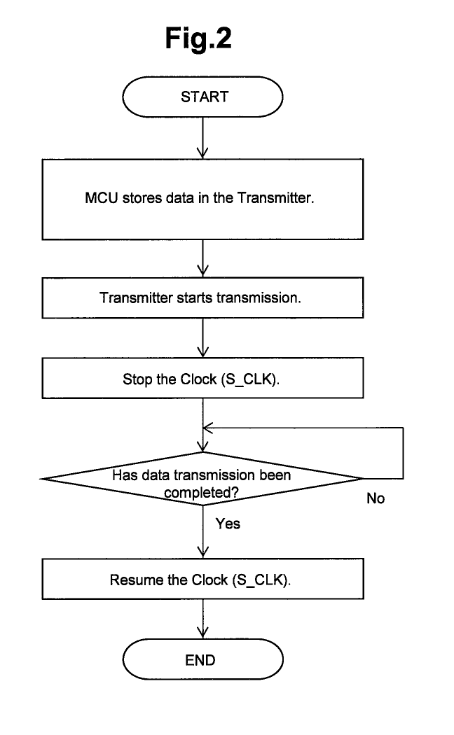

The action when the transmit terminal 100 sends data to the receive terminal 500 will be described with reference to FIGS. 2 to 4. FIG. 2 is a flowchart in case that the transmit terminal 100 according to the first embodiment of the invention sends data to the receive terminal 500. In the transmit terminal 100, the micro controller unit 101 sends the transmitter 102 data to be transmitted. The data is stored in the transmit buffer 107 in the transmitter 102 once. After the data to be transmitted is stored in the transmit buffer 107, the transmitter 102 starts to send the data to the receive terminal 500. During this action, the micro controller unit 101 stops the clock S_CLK to the interface between the micro controller unit 101 and transmitter 102, and stops the action of the interface circuit 106 of the micro controller unit 101, and the action of the interface circuit 114 of the transmitter 102. After data transmission from the transmit terminal 100 to the receive terminal 500 has been finished, the operation of the clock S_CLK is resumed, and communication between the micro controller unit 101 and transmitter 102 is performed routinely. Although no special restriction is intended, the interface circuit 114 disables an input action to the input buffer 200 when the clock signal S_CLK is stopped. Thus, noise is prevented from being caused by a malfunction of the input buffer 200. This function only works subsidiarily to the stop of the clock signal S_CLK.

Stopping communication between the micro controller unit 101 and transmitter 102 during the time when the transmitter 102 sends data to the other receive terminal 500 in this way, the following are made possible: to reduce the influence of digital noise coming from the interface circuit of the micro controller unit 101 and transmitter 102; and to prevent the degradation of the performance of communication between the transmit terminal 100 and receive terminal 500, i.e. the deterioration of the bit error rate and packet error rate.

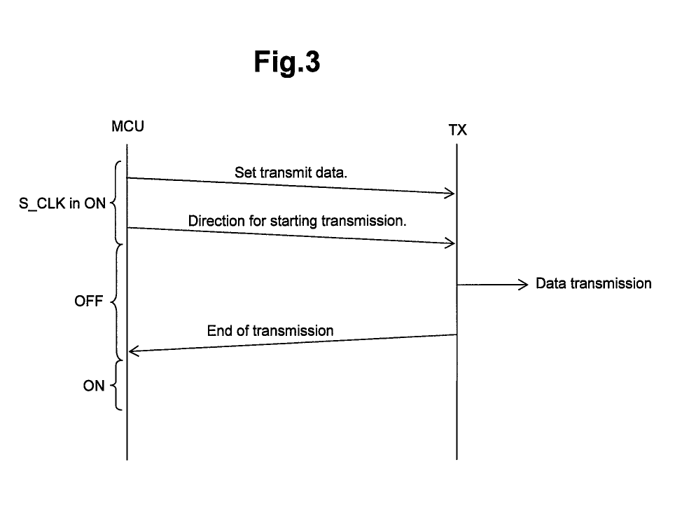

FIG. 3 is a sequence diagram showing a control sequence in connection with the micro controller unit 101 and transmitter 102 in case that the transmit terminal 100 according to the first embodiment of the invention transmits data to the receive terminal 500. The micro controller unit 101 sets data to be transmitted on the transmitter 102, first. Then, the micro controller unit 101 issues the transmitter 102 with a direction for starting data transmission. In response to the direction, the transmitter 102 starts to send data. After having issued the transmitter 102 with the direction for starting data transmission, the micro controller unit 101 stops the clock S_CLK to the interface. After having finished data transmission to the receive terminal 500, the transmitter 102 sends the micro controller unit 101 the message, “transmission has been finished”, by the signal S_TXMNT. On receipt of the message, the micro controller unit 101 resumes the operation of the clock S_CLK for the interface circuit.

As described above, the micro controller unit 101 stops the clock S_CLK after having issued the transmitter 102 with a direction for starting transmission, which makes it possible to reduce the influence of digital noise coming from the interface circuit. Further, after having completed data transmission, the transmitter 102 sends the micro controller unit 101 a notice of completion of transmission, whereby the micro controller unit 101 resumes the operation of the clock S_CLK. Thus, it becomes possible to resume communication between the micro controller unit 101 and transmitter 102.

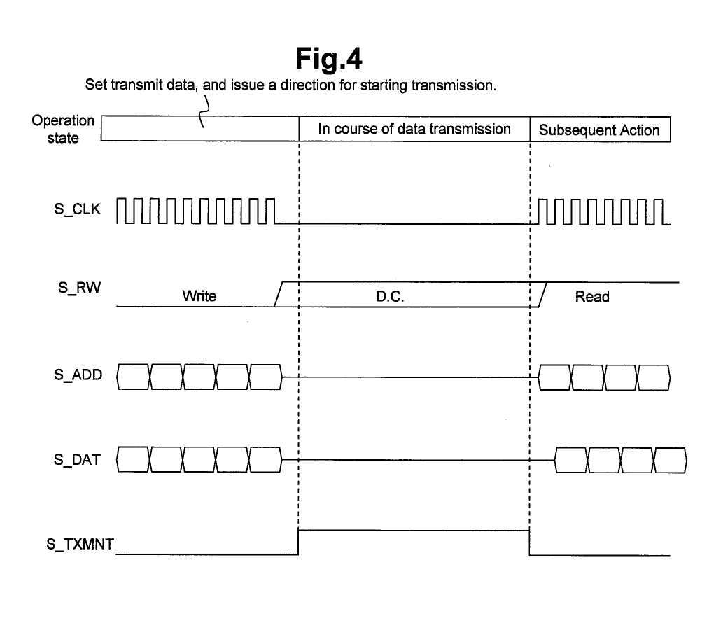

FIG. 4 shows an example of the timing chart of actions of the transmit terminal 100 in case that the transmit terminal 100 according to the first embodiment of the invention transmits data to the receive terminal 500. While the micro controller unit 101 sets data to be transmitted on the transmitter 102 and directs the transmitter to start transmission, the clock S_CLK and the interface circuit between the micro controller unit 101 and transmitter 102 are in action, and a predetermined data write is performed on a certain address. In addition, the micro controller unit 101 reads data from a certain address as required. Incidentally, the example shown in the drawing is an example of data write.

After having issued a direction for starting transmission, the micro controller unit 101 stops the clock S_CLK. Concurrently with this, the micro controller unit stops actions associated with the address line and data line. In response to the direction from the micro controller unit 101, the transmitter 102 starts the transmit action. At this time, the transmitter brings the value of the transmit monitor signal S_TXMNT to High level (HI level) in order to inform the micro controller unit 101 that it is in action of transmission. After completion of transmission, the transmitter 102 turns the value of the transmit monitor signal S_TXMNT to Low level (LO level), and informs the micro controller unit 101 that the transmission has been completed. The micro controller unit 101 monitors the transmit monitor signal S_TXMNT, and it recognizes that transmission has been terminated at the time when the monitor signal is changed from HI level to LO level. When accepting, as a trigger, the change of the transmit monitor signal S_TXMNT, the micro controller unit 101 resumes the operation of the clock S_CLK, thereby to restart communication between the micro controller unit 101 and transmitter 102. After that, the micro controller unit 101 begins a subsequent action, e.g. acquisition of an error message at the time of transmission.

Using the transmit monitor signal S_TXMNT to inform the micro controller unit 101 of the operation state of the transmitter 102 through a dedicated line, it becomes possible to stop the clock signal S_CLK. The influence of digital noise coming from the interface circuit can be reduced by stopping the clock signal S_CLK, and therefore it becomes possible to prevent the degradation of the communication performance. Now, it is noted that the polarity of each signal just shows an example, and it may be reversed.

As described above, use of the transmit terminal according to the first embodiment of the invention can restrain digital noise from going into an analog circuit. In other words, by stopping the clock signal S_CLK during the time when the analog circuit is in action, the noise source can be eliminated to prevent the performance of the analog circuit from being degraded. This system is such that noise is reduced by stopping a clock, and does not offer a measure in terms of hardware such as the conventional means of widening the physical distance between digital and analog circuits. Therefore, the system is adequate for downsizing terminals.

### Second Embodiment

As to the second embodiment of the invention, the description will be presented focusing on the receive terminal for receiving data.

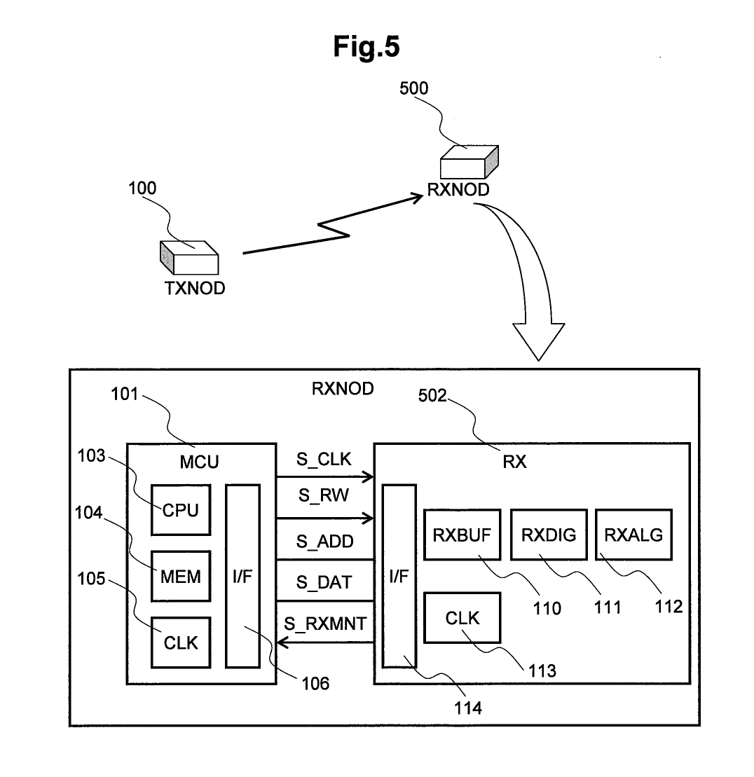

FIG. 5 shows a communication system according to the second embodiment of the invention, and it also shows a configuration of a receive terminal thereof. The communication system according to the second embodiment of the invention includes a transmit terminal (TXNOD) 100, and a receive terminal (RXNOD) 500. The receive terminal 500 receives data from the transmit terminal 100.

The receive terminal 500 includes a micro controller unit (MCU) 101 as a semiconductor device for control, and a receiver (RX) 502 as a semiconductor device for communication. The micro controller unit includes a central processing unit (CPU) 103, a memory (MEM) 104, a clock generator (CLK) 105, and an interface (I/F) 106. The receiver 502 includes a receive buffer (RXBUF) 110, a receive digital circuit (RXDIG) 111, a receive analog circuit (RXALG) 112, a clock generator (CLK) 113, and an interface circuit (I/F) 114.

The micro controller unit 101 and receiver 502 are connected with each other by a clock signal line (S_CLK), a signal line (S_RW) for selecting read or write, an address line (S_ADD), a data line (S_DAT), and a receive monitor signal line (S_RXMNT). The clock signal S_CLK is provided to the receiver 502 from the micro controller unit 101, which is used as a clock in communication between the micro controller unit 101 and receiver 502. The address line S_ADD is used to indicate an address of a register or buffer to be accessed. To the data line S_DAT, data to be written to or read from an address indicated by the address line S_ADD is output. Whether data is read or written is specified by the read/write signal line (S_RW). The receive monitor signal line S_RXMNT is one used to inform the micro controller unit 101 of the operation state of the receiver 502.

The receive terminal 500 according to the second embodiment of the invention is a device such that both analog and digital circuits are mounted mixedly. The analog circuit refers to the receive analog circuit 112 of the receiver 502. The digital circuit refers to the micro controller unit 101, and the receive buffer 110, receive digital circuit 111, clock generator 113 and interface circuit 114 of the receiver 502. The goal that the receive terminal according to the second embodiment of the invention aims at is to reduce noise resulting from communication between the micro controller unit 101 and receiver 502, which is the same as that of the transmit terminal according to the first embodiment of the invention. Specifically, noise caused by communication between the micro controller unit 101 and receiver 502 can go into the receive analog circuit 112 of the receiver 502. The noise having entered the receive analog circuit 112 degrades the characteristics of the receive analog circuit 112, and more concretely such noise deteriorates the bit error rate and packet error rate.

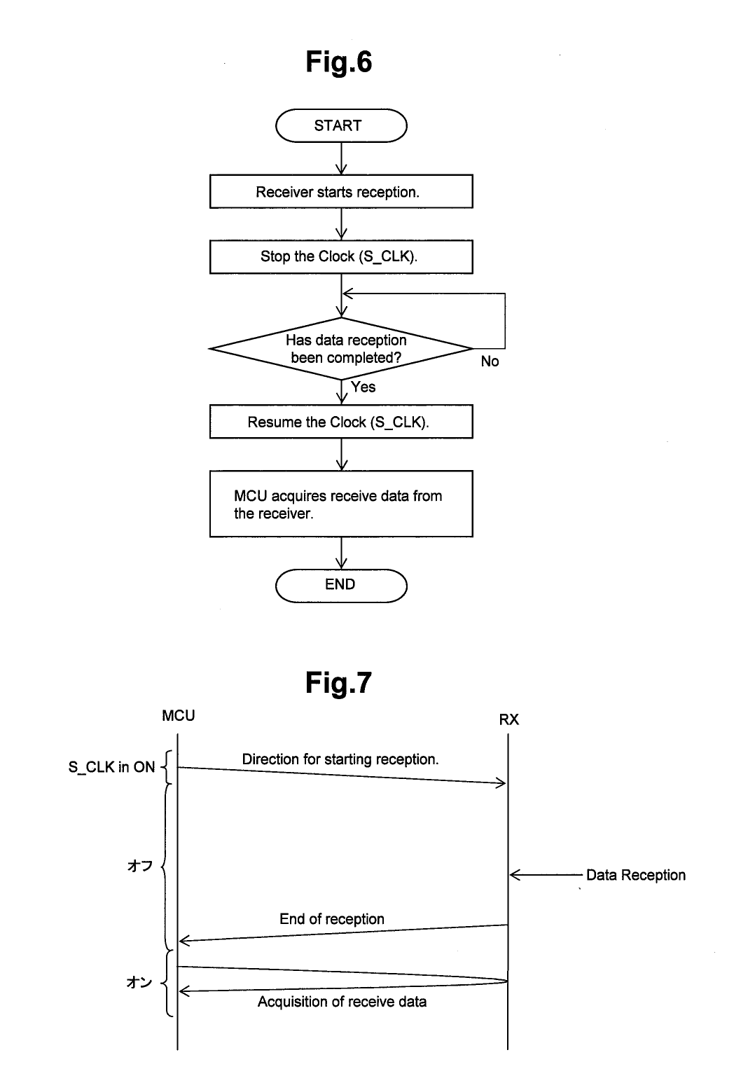

The receiver 502 has an interface circuit 114, which is identical to that of the transmitter 102. As in the case of the transmitter 102, it is expected that a large spurious noise arises in the interface circuit 114 on the controlled side. To reduce the influence of the spurious noise on the analog circuit, the micro controller unit 101 performs control so that outputting the clock signal S_CLK to the receiver 502 is stopped until it receives a notice of the end of a receive action from the receiver 102 by use of the signal S_RXMNT after having issued the receiver 502 with a direction of the receive action. This will be described below further in detail with reference to FIGS. 6 to 8.

FIG. 6 is a flowchart in case that the receive terminal 500 according to the second embodiment of the invention receives data from the transmit terminal 100. In case that the receive terminal 500 receives data, the receiver 502 starts a data receive action. At this time, the micro controller unit 101 stops the clock S_CLK to the interface circuit between the micro controller unit 101 and receiver 502, and stops the action of the interface circuit 106 of the micro controller unit 101 and the action of the interface circuit 114 of the receiver 502. The data received by the receiver 502 is stored in the receive buffer 110 in the receiver 502 once. After having received data, the receive terminal 500 resumes the operation of the clock S_CLK. Concurrently with the resumption of the operation of the clock S_CLK, communication between the micro controller unit 101 and receiver 502 is started routinely. Then, the micro controller unit 101 read data stored in the receive buffer 110.

Stopping communication between the micro controller unit 101 and receiver 502 during the time when the receiver 502 receives data from other communication terminal in this way, the following are made possible: to reduce the influence of digital noise coming from the interface circuit of the micro controller unit 101 and receiver 502; and to prevent the degradation of the receive performance of the receive terminal 500, i.e. the deterioration of the bit error rate and packet error rate.

FIG. 7 is a sequence diagram showing a control sequence in connection with the micro controller unit 101 and receiver 502 in case that the receive terminal 500 according to the second embodiment of the invention receives data from the transmit terminal 100. The micro controller unit 101 issues the receiver 502 with a direction for starting data reception. In response to the direction, the receiver 502 starts data reception. After having issued the receiver 502 with the direction for starting the reception, the micro controller unit 101 stops the clock SCLK to the interface. After having finished data reception from the transmit terminal 100, the receiver 502 sends the micro controller unit 101 the message, “reception has been finished”. On receipt of the message, the micro controller unit 101 resumes the operation of the clock S_CLK for the interface circuit. After that, the micro controller unit 101 acquires data received from the receiver 502.

As described above, the micro controller unit 101 stops the clock S_CLK after having issued the receiver 502 with a direction for starting reception, which makes it possible to reduce the influence of digital noise coming from the interface circuit. Further, after having completed data reception, the receiver 502 sends the micro controller unit 101 a notice of completion of reception, whereby the micro controller unit 101 resumes the operation of the clock S_CLK. Thus, it becomes possible to resume communication between the micro controller unit 101 and receiver 502.

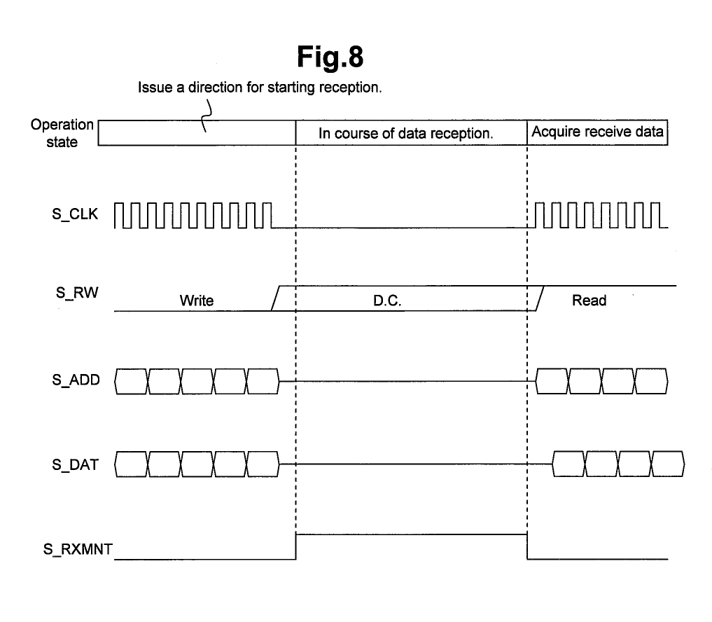

FIG. 8 shows an example of the timing chart of actions of the receive terminal 500 in case that the receive terminal 500 according to the second embodiment of the invention receives data from the transmit terminal 100. While the micro controller unit 101 directs the receiver 502 to start reception, the clock S_CLK and the interface circuit between the micro controller unit 101 and receiver 502 are in action, and a predetermined data write is performed on a certain address. In addition, the micro controller unit 101 reads data from a certain address as required. Incidentally, the example shown in the drawing is an example of data write.

After having issued a direction for starting reception, the micro controller unit 101 stops the clock S_CLK. Concurrently with this, the micro controller unit stops actions associated with the address line and data line. In response to the direction from the micro controller unit 101, the receiver 502 starts the receive action. At this time, the transmitter brings the value of the receive monitor signal S_RXMNT to High level (HI level) in order to inform the micro controller unit 101 that it is in action of reception. After completion of reception, the receiver 502 turns the value of the receive monitor signal S_RXMNT to Low level (LO level), and informs the micro controller unit 101 that the reception has been completed. The micro controller unit 101 monitors the receive monitor signal S_RXMNT, and it recognizes that reception has been terminated at the time when the monitor signal is changed from HI level to LO level. When accepting, as a trigger, the change of the receive monitor signal S_RXMNT, the micro controller unit 101 resumes the operation of the clock S_CLK, thereby to restart communication between the micro controller unit 101 and receiver 502. After that, the micro controller unit 101 acquires data received from the receiver 502. Using the receive monitor signal S_RXMNT to inform the micro controller unit 101 of the operation state of the receiver 502 through a dedicated line, it becomes possible to know the time of resuming the supply of the clock signal S_CLK.

The influence of digital noise coming from the interface circuit can be reduced by stopping the clock signal S_CLK, and therefore it becomes possible to prevent the degradation of the communication performance. Now, it is noted that the polarity of each signal just shows an example, and it may be reversed.

As described above, use of the receive terminal according to the second embodiment of the invention can restrain digital noise from going into an analog circuit. In other words, by stopping the clock signal S_CLK during the time when the analog circuit is in action, the noise source can be eliminated to prevent the performance of the analog circuit from being degraded. This system is such that noise is reduced by stopping a clock, and does not offer a measure in terms of hardware such as the conventional means of widening the physical distance between digital and analog circuits. Therefore, the system is adequate for downsizing terminals.

### Third Embodiment

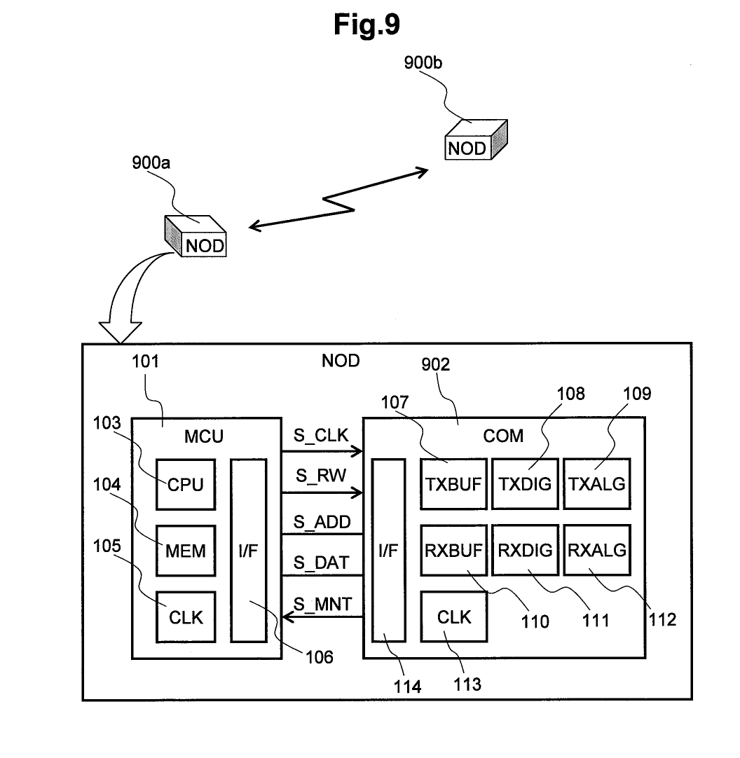

The third embodiment according to the invention will be described with reference to FIGS. 9 to 13. FIG. 9 shows a communication system according to the third embodiment of the invention, and it also shows a configuration of a communication terminal thereof. The communication system according to the third embodiment of the invention includes a plurality of communication terminals (NOD) 900a, 900b, and so forth. The communication terminal 900a communicates with the communication terminal 900b. The description below deals with a one-to-one communication. However, it likewise applies to one-to-many communication and many-to-many communication regardless of whether a communication channel thereof is wired or wireless one. Incidentally, the subscripts a, b, and so forth represent that the members or parts referred to by reference numerals accompanied by the subscripts are identical to one another. Such subscripts are omitted in the description below if not particularly required.

The communication terminal 900 includes a micro controller unit (MCU) 101 as one semiconductor device for control, and a communication device (COM) 902 as one semiconductor device for communication. The micro controller unit includes a central processing unit (CPU) 103, a memory (MEM) 104, a clock generator (CLK) 105, an interface (I/F) 106. The communication device 902 includes a transmit buffer (TXBUF) 107, a transmit digital circuit (TXDIG) 108, a transmit analog circuit (TXALG) 109, a receive buffer (RXBUF) 110, a receive digital circuit (RXDIG) 111, a receive analog circuit (RXALG) 112, a clock generator (CLK) 113 and an interface circuit (I/F) 114, and it serves as a transceiver part.

The micro controller unit 101 and communication device 902 are connected with each other by a clock signal line (S CLK), a signal line (S RW) for selecting read or write, an address line (S_ADD), a data line (S_DAT), and a monitor signal line (S_MNT). The clock signal S_CLK is provided to the communication device 902 from the micro controller unit 101, which is used as a clock in communication between the micro controller unit 101 and communication device 902. The address line S_ADD is used to indicate an address of a register or buffer to be accessed. To the data line S_DAT, data to be written to or read from an address indicated by the address line S_ADD is output. Whether data is read or written is specified by the read/write signal line (S_RW). The monitor signal line S_MNT is one used to inform the micro controller unit 101 of the operation state of the communication device 902.

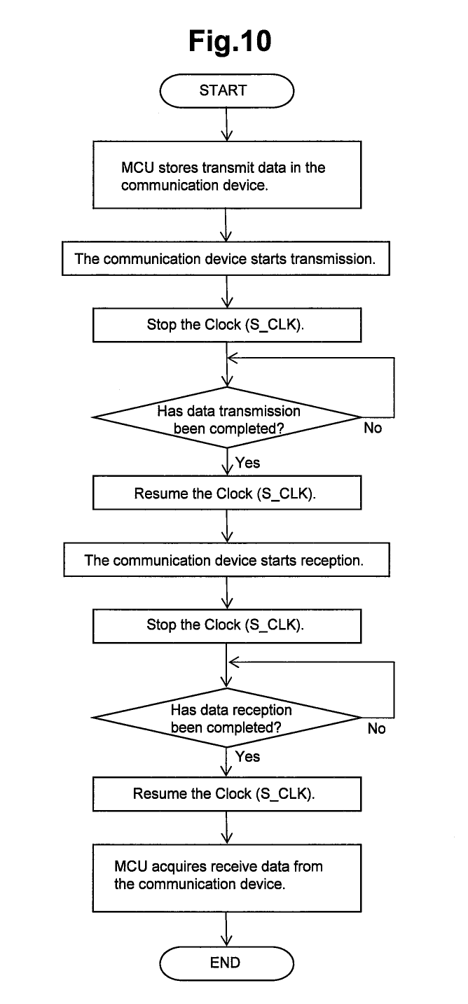

The communication terminal 900 according to the third embodiment of the invention basically performs actions consisting of the actions of the transmit terminal 100 according to the first embodiment of the invention and the actions of the receive terminal 500 according to the second embodiment of the invention. Specifically, the communication terminal 900 stops the operation of the clock S_CLK in the courses of transmission and reception, thereby to reduce the influence of digital noise on the analog circuit. In the case of simply adding the functions of the transmit terminal 100 and those of the receive terminal 500, two kinds of monitor signals, i.e. the transmit monitor signal S_TXMNT and receive monitor signal S_RXMNT are required. To avoid increasing the number of signal lines, the communication terminal according to the third embodiment of the invention monitors both transmit and receive states through one signal line using the monitor signal S_MNT. Next, the actions of the communication device according to the third embodiment of the invention will be described with reference to FIGS. 10 to 13.

FIG. 10 shows an example of the action flowchart of the communication terminal 900a according to the third embodiment of the invention. The actions in case the communication terminal 900a receives data from the communication terminal 900b after having transmitted data to the communication terminal 900b will be described with reference to the drawing. First, the micro controller unit 101 sends the communication device 902 data to be transmitted, and the data is once stored in the transmit buffer 107 in the communication device 902. After the data to be transmitted has been stored in the transmit buffer 107, the communication device 902 starts transmitting data to the communication terminal 900b. At this time, the micro controller unit 101 stops the clock S_CLK to the interface circuit 114 between the micro controller unit 101 and communication device 902, and stops the action of the interface circuit 106 of the micro controller unit 101 and the action of the interface circuit 114 of the communication device 902. After data transmission from the communication terminal 900a to the communication terminal 900b has been finished, the micro controller unit 101 is notified of that by means of the signal S_MNT, and resumes the action for supplying the clock S_CLK.

After that, when the micro controller unit 101 issues a direction of the receive action, the communication device 902 restarts the action of receiving data. At this time, the micro controller unit 101 stops the clock S_CLK to the interface between the micro controller unit 101 and communication device 902, and stops the action of the interface circuit 106 of the micro controller unit 101 and the action of the interface circuit 114 of the communication device 902. The data received by the communication device 902 is once stored in the receive buffer 110 in the communication device 902. In the communication terminal 900, after data reception has been finished, the micro controller unit 101 is notified of that by means of the signal S_MNT, whereby supply of the clock S_CLK is resumed. Concurrently with the resumption of the operation of the clock S_CLK, communication between the micro controller unit 101 and communication device 902 is started routinely, and the micro controller unit 101 reads data stored in the receive buffer 110.

Stopping communication between the micro controller unit 101 and communication device 902 during the time when the communication device 902 sends data to other communication terminal, and the time when the communication device 902 receives data from other communication terminal in this way, the following are made possible: to reduce the influence of digital noise coming from the interface circuit of the micro controller unit 101 and communication device 902; and to prevent the degradation of the performance of communication between the communication terminal 900a and other communication terminal 900b, i.e. the bit error rate and packet error rate.

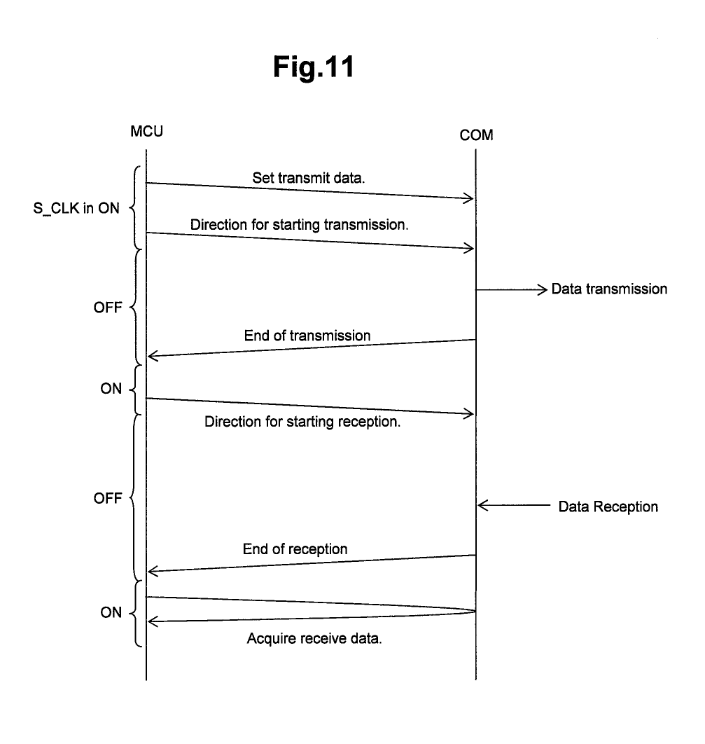

FIG. 11 is a sequence diagram showing a control sequence in connection with the micro controller unit 101 and communication device 902 in case that the communication terminal 900a according to the third embodiment of the invention receives data from the communication terminal 900b after having transmitted data to the communication terminal 900b. First, the micro controller unit 101 sets data to be transmitted on the communication device 902. Then, the micro controller unit 101 issues the communication device 902 with a direction for starting data transmission. In response to the direction, the communication device 902 starts data transmission. After having issued the communication device 902 with the direction for starting transmission, the micro controller unit 101 issues stops the clock S_CLK to the interface. After having finished the transmission to the communication terminal 900b, the communication device 902 sends the micro controller unit 101 the message, “transmission has been finished”. On receipt of the message, the micro controller unit 101 resumes the operation of the clock S_CLK to the interface circuit.

After that, the micro controller unit 101 issues the communication device 902 with a direction for starting data reception. In response to the direction, the communication device 902 starts data reception. After having issued the communication device 902 with the direction for starting the reception, the micro controller unit 101 stops the clock S_CLK to the interface. After having finished data reception from the communication terminal 900b, the communication device 902 sends the micro controller unit 101 the message, “reception has been finished”. On receipt of the message, the micro controller unit 101 resumes the operation of the clock S_CLK to the interface circuit. After that, the micro controller unit 101 acquires data received from the communication device 902.

As described above, the micro controller unit 101 stops the clock S_CLK after having issued the communication device 902 with the direction for starting transmission, and after having issued the communication device 902 with the direction for starting reception, which makes it possible to reduce the influence of digital noise coming from the interface circuit. Further, After completion of data transmission/reception, the communication device 902 sends the micro controller unit 101 a notice of completion of transmission/reception, whereby the micro controller unit 101 resumes the operation of the clock S_CLK. Thus, it becomes possible to resume communication between the micro controller unit 101 and communication device 902.

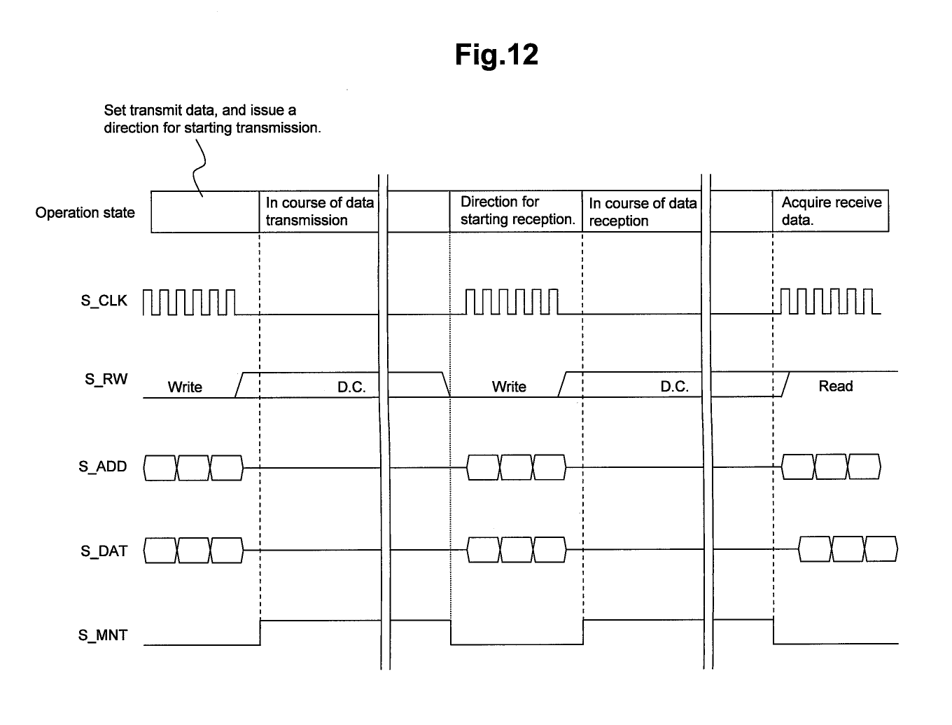

FIG. 12 shows an example of the timing chart of actions of the communication terminal 900a in case that the communication terminal 900a according to the third embodiment of the invention receives data after having transmitted data to the communication terminal 900b. While the micro controller unit 101 sets data to be transmitted on the communication device 902 and directs the communication device 902 to start transmission, the clock S_CLK and the interface circuit between the micro controller unit 101 and communication device 902 are in action, and a predetermined data write is performed on a certain address. In addition, the micro controller unit 101 reads data from a certain address as required. Incidentally, the example shown in the drawing is an example of data write.

After having issued a direction for starting transmission, the micro controller unit 101 stops the clock S_CLK. Concurrently with this, the micro controller unit 101 stops actions associated with the address line and data line. In response to the direction from the micro controller unit 101, the communication device 902 starts the transmit action. At this time, the communication device 902 turns the value of the monitor signal S_MNT to HI level in order to inform the micro controller unit 101 that it is in action of transmission. After completion of transmission, the communication device 902 turns the value of the monitor signal S_MNT to LO level, and informs the micro controller unit 101 that the transmission has been completed. The micro controller unit 101 monitors the monitor signal S_MNT, and it recognizes that transmission has been terminated at the time when the monitor signal is changed from HI level to LO level. When accepting, as a trigger, the change of the monitor signal S_MNT, the micro controller unit 101 resumes the operation of the clock S_CLK, thereby to restart communication between the micro controller unit 101 and communication device 902.

After that, the micro controller unit 101 directs the communication device 902 to start reception. After having issued the direction for starting reception, the micro controller unit 101 stops the clock S_CLK. Concurrently with this, micro controller unit 101 stops the actions associated with the address line and data line. In response to a direction from the micro controller unit 101, the communication device 902 starts the receive action. At this time, the communication device 902 turns the value of the monitor signal S_MNT to HI level in order to inform the micro controller unit 101 that it is in action of reception. After completion of reception, the communication device 902 turns the value of the monitor signal S_MNT to LO level, and informs the micro controller unit 101 that the reception has been completed. The micro controller unit 101 monitors the monitor signal S_MNT, and it recognizes that reception has been terminated at the time when the monitor signal is changed from HI level to LO level. When accepting, as a trigger, the change of the monitor signal S_MNT, the micro controller unit 101 resumes the operation of the clock S_CLK, thereby to restart communication between the micro controller unit 101 and communication device 902. After that, the micro controller unit 101 acquires data received from the communication device 902.

Using the monitor signal S_MNT to inform the micro controller unit 101 of the operation state of the communication device 902 through a dedicated line, it becomes possible to know the time of resuming the supply of the clock signal S_CLK. As the monitor signal S_CLK, any signal will be sufficient as long as it serves as a trigger signal for activating the clock signal S_CLK. Therefore, the monitor signal S_CLK may be arranged to function in the same way regardless of whether the monitor signal shows the end of transmission or the end of reception. In other words, a signal showing the end of transmission and a signal showing the end of reception may share one signal line. By stopping the clock signal S_CLK in this way, the influence of digital noise coming from the interface circuit can be reduced, and the deterioration of the communication performance can be prevented. Now, it is noted that the polarity of each signal just shows an example, and it may be reversed. The same is true for cases where transmit and receive actions are performed in parallel because the dual band is adopted.

As described above, use of the communication terminal according to the third embodiment of the invention can restrain digital noise from going into an analog circuit. In other words, by stopping the clock signal S_CLK during the time when the analog circuit is in action, the noise source can be eliminated to prevent the performance of the analog circuit from being degraded. This system is such that noise is reduced by stopping a clock, and does not offer a measure in terms of hardware such as the conventional means of widening the physical distance between digital and analog circuits. Therefore, the system is adequate for downsizing terminals.

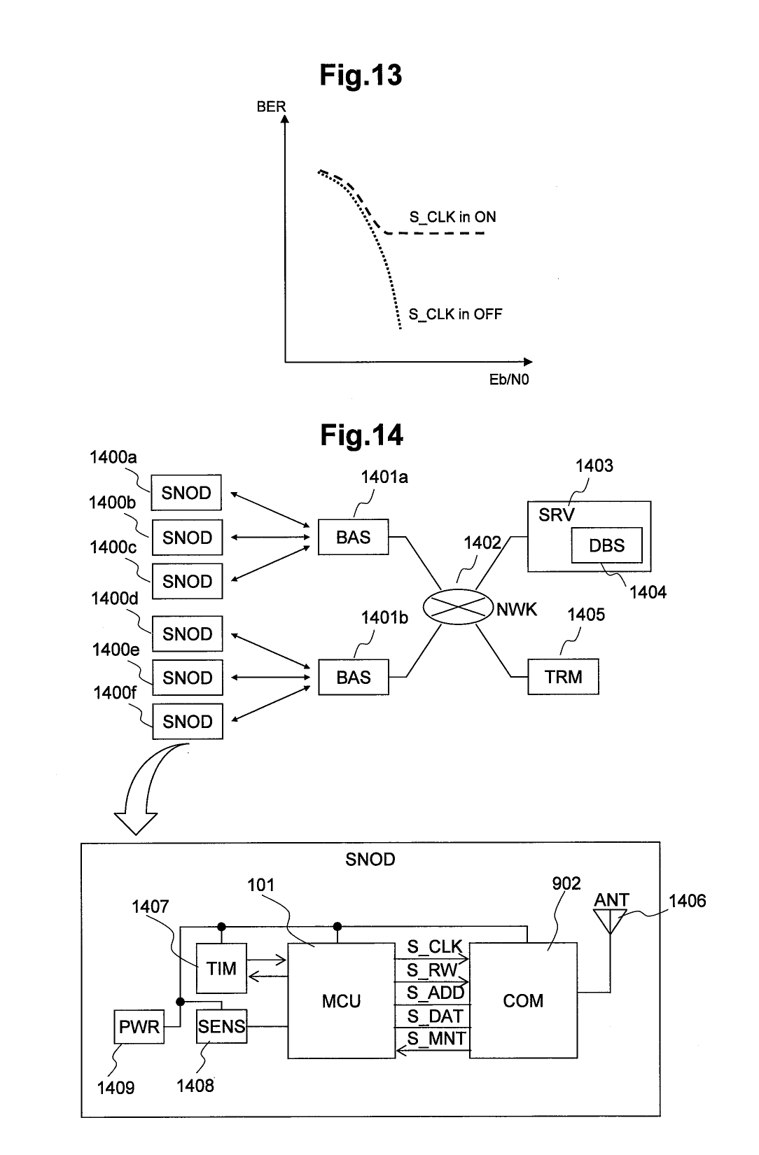

FIG. 13 shows examples of the relation between signal-to-noise ratios (Eb/NO) and bit error rates (BER) in the case of the clock S_CLK in ON and the case of the clock S_CLK in OFF. In the condition where the clock S_CLK is in ON, digital noise goes into the transmit analog circuit and receive analog circuit, degrading their performances. The noise is put on the analog circuit and therefore, the influence thereof arises as a noise floor on the BER characteristic. On this account, even in the case of a raised signal-to-noise ratio, a situation such that BER characteristic is not improved can develop. In contrast, if the clock S_CLK is stopped during the time when the analog circuit is working, no digital noise goes into the analog circuit. Therefore, the noise floor never arises in BER characteristic. If the signal-to-noise ratio is improved, better BER characteristic can be achieved. Thus, BER characteristic is improved by stopping the clock S_CLK during the time when the analog circuit is working. Now, it is noted that the BER characteristic of FIG. 13 is just an example, which is not limited to the characteristic which exhibits a noise floor like this.

While the above description has been presented about the case where the micro controller unit 101 and communication device 902 are bus-interfaced, the invention is not so limited. The same noise reduction effect can be achieved by stopping the clock signal even in the case of a serial interface, for example.

Also, while the method for reducing noise has been described concerning cases that the communication device 902 transmits data, and receives data, the invention is not so limited. For example, the influence of noise may be reduced during the time when an analog circuit, such as a carrier sense circuit, is in action.

### Fourth Embodiment

An example of application of the communication terminal according to the invention will be described. According to the invention, it is possible to restrain digital noise from going into an analog circuit, and the method for so doing is adequate for a communication terminal which needs to be downsized. As an example of its application, the application to a sensor network system, hereinafter referred to as “Sensor Net” for short, can be conceived. Sensor Net is a wireless communication system such that a terminal having a sensor and a wireless communication function, hereinafter referred to as “sensor node”, is used to capture various information pieces of the real world into an information processing device in real time. Sensor nodes are placed everywhere and on everything, and information pieces gathered by the sensors are sent to a network. The data so gathered are processed into various forms, and fed back to the real world. Such Sensor Net has been under consideration about applications to various fields such as logistics, healthcare, and quality control. To set sensor nodes at various places, it is de rigueur to scale down the sensor nodes.

FIG. 14 shows a configuration of Sensor Net, which is an example of the communication system in association with the invention, which includes sensor nodes (SNOD) 1400a, 1400b, 1400c, 1400d, 1400e, 1400f, and so forth, base stations (BAS) 1401a and 1401b, a network (NWK) 1402, a server (SRV) 1403, and a terminal (TRM) 1405. The server 1403 has a database (DBS) 1404. Incidentally, the subscripts a, b, and so forth represent that the members or parts referred to by reference numerals accompanied by the subscripts are identical to one another. Such subscripts are omitted in the description below if not particularly required.

The sensor node 1400 sends the base station 1401 data acquired by use of the sensor. The base station 1401 manages a number of sensor nodes 1400, and gathers data from the sensor nodes 1400. The data so gathered are sent to the server 1403 through the network 1402, and then stored in the database 1404 inside the server. The server 1403 analyzes the data stored in the database 1404. The analyzed data and data stored in the database 1404 can be accessed from the terminal 1405.

When the method for reducing noise according to the invention is applied to the sensor nodes, a communication terminal with a compact size and a high communication performance can be materialized. The sensor node 1400 includes a micro controller unit 101, a communication device 902, an antenna (ANT) 1406, a timer (TIM) 1407, a sensor (SENS) 1408, and a power source (PWR) 1409.

The micro controller unit 101 captures data from the sensor 1408. The sensor 1408 is used to gauge its surrounding environment. Examples of the sensor 1408 include a temperature sensor, a humidity sensor, an illumination sensor, an acceleration sensor, an infrared sensor and a barometric sensor. The micro controller unit 101 processes data captured from the sensor 1408 on an as-needed basis, and sends out the data to the base station 1401 through the communication device 902 and antenna 1406. The communication device 902 receives data from the base station 1401. The data received from the base station 1401 are analyzed in the micro controller unit 101, and are subjected to a processing such as data retransmission on an as-needed basis. The timer 1407 is used to determine the time of sensing, and to associate sensed data to the time. The power source for the sensor node is provided by the power source 1409.

The noise reduction effect can be gained by arranging control of the micro controller unit 101 and communication device 902 in the sensor node in the same way as in the communication terminal according to the third embodiment of the invention. Specifically, after having directed the communication device 902 to start transmission and to start reception, the micro controller unit 101 stops the clock S_CLK, whereby the influence of digital noise coming from the interface circuit can be reduced. Besides, after completion of data transmission/data reception, the communication device 902 sends the micro controller unit 101 a notice of completion of transmission/completion of reception, whereby the micro controller unit 101 can resume the operation of the clock S_CLK, and thus communication between the micro controller unit 101 and communication device 902 can be restarted. The method for reducing noise does not require to widen the physical distance, which is a requirement for a conventional means, and is adequate for downsizing of sensor nodes.

While the invention made by the inventor has been concretely described above based on the embodiments, the invention is not limited to the embodiments. It is needless to say that various changes or modifications may be made without departing from the scope of the invention.

For example, in the above description it is assumed that the micro controller unit 101 and communication device 902 are composed of different LSIs. However, the invention is not limited to this. Even in the case where the micro controller unit and communication device are integrated into one LSI, and they are operated in asynchronization with each other, the method for reducing noise according to the invention is useful. Specifically, the effect of noise reduction can be gained by stopping a clock for communication between CPU block and communication device block in LSI during the time when the analog circuit is in action. The communication system is not limited to Sensor Net.

What is claimed is:

1. A communication device comprising:
a communication part; and
a control part, the communication and control parts operated in asynchronization with each other,
wherein the communication part has an analog circuit for communication and an interface circuit connected with the control part,
the interface circuit synchronously interfaces between the communication and control parts in synchronization with a first clock signal output from the control part, and
after having issued a direction of a communication action to the communication part, the control part stops supply of the first clock signal to the communication part until receiving a notice of end of a communication action relevant to a direction thereof form the communication part.

2. The communication device according to claim 1, wherein the communication part is a transmit part.

3. The communication device according to claim 2, wherein the control part provides transmit data to the transmit part separately from a direction for a transmit action.

4. The communication device according to claim 2, wherein the transmit part outputs a notice signal for notifying the control part of a transmit operation state, and
the control part accepts end of the transmit action with aid of the notice signal.

5. The communication device according to claim 1, wherein the communication part is a receive part.

6. The communication device according to claim 5, wherein the receive part stores receive data in a data buffer, and then sends a notice of end of a receive action to the control part.

7. The communication device according to claim 5, wherein the receive part outputs a notice signal to notify the control part of a receive operation state, and
the control part accepts end of the receive action with aid of the notice signal.

8. The communication device according to claim 1, wherein the communication part is a transceiver part.

9. The communication device according to claim 8, wherein the transceiver part outputs a notice signal to notify the control part of a communication operation state,
the control part accepts end of the communication operation with aid of the notice signal,
a first level of the notice signal shows that the transceiver part is in course of transmission or reception, and
a second level thereof shows that the transceiver part is in course of neither transmission nor reception.

10. The communication device according to claim 1, wherein the interface circuit has: a first latch circuit operable to latch a signal supplied to an input buffer from the control part in synchronization with the first clock signal;
a second latch circuit operable to latch the latched signal of the first latch circuit in synchronization with a second clock signal generated in the communication part;
a third latch circuit operable to latch a signal to be output to the control part in synchronization with the second clock signal; and
a fourth latch circuit operable to latch the latched signal of the third latch circuit in synchronization with the first clock signal, and to provide the latched signal to an output buffer.

11. The communication device according to claim 10,wherein the first clock signal is different from the second clock signal in frequency.

12. The communication device according to claim 1, comprising:
a semiconductor integrated circuit chip constituting the control part; and
a semiconductor integrated circuit chip constituting the communication part,
whereby the communication device is modularized.

13. A communication system comprising:
a plurality of communication devices,
wherein at least one communication device has a communication part and a control part, which are operated in asynchronization with each other,
the communication part has an analog circuit for communication, and an interface circuit connected with the control part,
the interface circuit synchronously interfaces between the communication part and control part in synchronization with a first clock signal output from the control part, and
the control part issues the communication part with a direction of a communication action, and then stops supplying the first clock signal to the communication part during time when the analog circuit is in action.

14. The communication system according to claim 13, wherein after having issued the communication part with a direction of a communication action, the control part stops supplying the first clock signal to the communication part until receiving a notice signal of end of a communication action associated with the direction from the communication part.

15. The communication system according to claim 13, wherein at least one of the communication devices is a base station,
the remaining communication devices are terminals, and
the terminal has a sensor, and sends data captured by the sensor to the base station.

16. The communication system according to claim 15, further comprising a server with which the base station is connected through a network.
